(19) United States
(12) Patent Application Publication
(10) Pub. No.: US 2024/0072352 A1
(43) Pub. Date: Feb. 29, 2024

(54) ENCLOSURE FOR RECHARGEABLE ENERGY STORAGE SYSTEM INCLUDING HERMETIC SEALING ENCLOSURE AND STRUCTURAL HOUSING COMPONENT

(71) Applicant: GM GLOBAL TECHNOLOGY OPERATIONS LLC, Detroit, MI (US)

(72) Inventors: Hui-ping WANG, Troy, MI (US); Lu HUANG, Troy, MI (US); William P. PAYNE, Macomb, MI (US); Hui WANG, Novi, MI (US); Blair E. CARLSON, Ann Arbor, MI (US)

(21) Appl. No.: 17/893,365

(22) Filed: Aug. 23, 2022

(51) Int. Cl. H01M 50/24; H01M 50/227; H01M 50/231; H01M 50/238; H01M 50/262; H01M 50/271; H01M 50/308; H01M 50/342; H01M 50/383

(52) U.S. Cl. CPC H01M 50/24; H01M 50/227; H01M 50/231; H01M 50/238; H01M 50/262; H01M 50/271; H01M 50/308; H01M 50/3425; H01M 50/383; H01M 2200/20

(57) ABSTRACT

An enclosure for a rechargeable energy storage system (RESS) includes a hermetic sealing enclosure and a structural housing component configured to support the hermetic sealing enclosure. The hermetic sealing enclosure is arranged on the structural housing component. The hermetic sealing enclosure is configured to house the RESS and provide a hermetic seal.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to enclosures for rechargeable energy storage systems.

Electric vehicles (EVs) such as battery electric vehicles (BEVs), hybrid vehicles, and/or fuel cell vehicles include one or more electric machines and a rechargeable energy storage system (RESS). The RESS provides power to and receives power from the one or more electric machines and/or a utility. The RESS includes one or more battery cells, modules and/or packs. A power control system is used to control charging and/or discharging of the RESS during charging and/or driving. The RESS is typically arranged in an enclosure providing both structural protection and hermetic sealing of the RESS.

### SUMMARY

An enclosure for a rechargeable energy storage system (RESS) includes a hermetic sealing enclosure and a structural housing component configured to support the hermetic sealing enclosure. The hermetic sealing enclosure is arranged on the structural housing component. The hermetic sealing enclosure is configured to house the RESS and provide a hermetic seal.

In other features, the hermetic sealing enclosure includes a base portion and a cover configured to attach to the base portion. The hermetic sealing enclosure includes an opening and a drawstring configured to close the opening. The hermetic sealing enclosure includes an opening and a zipper configured to close the opening.

In other features, the structural housing component includes a bottom surface and side walls extending from the bottom surface and the hermetic sealing enclosure is arranged on the bottom surface between the side walls. At least one of the side walls and the bottom surface include holes to reduce a weight of the structural housing component.

In other features, the hermetic sealing enclosure includes gas vents that are configured to release pressure from the hermetic sealing enclosure when pressure within the hermetic sealing enclosure is greater than a predetermined pressure. The gas vents are selected from a group consisting of a pressure sensitive plug and a polymer layer arranged in a hole in the hermetic sealing enclosure.

In other features, the hermetic sealing enclosure is made of a material selected from a group consisting of fabric, metal, composite material, rubber, polymer and/or combinations thereof. The hermetic sealing enclosure is made of a flexible material that is rolled to close an opening of the hermetic sealing enclosure. The structural housing component includes a bottom surface, a frame and tubes extending between the bottom surface and the frame.

In other features, a coating that is at least one of fire resistant and electrically insulating is arranged on at least one of an inner surface and an outer surface of the hermetic sealing enclosure.

An enclosure for a rechargeable energy storage system (RESS) includes a hermetic sealing enclosure and a structural housing component including side walls extending from a bottom surface. The hermetic sealing enclosure is arranged on the bottom surface between the side walls. The hermetic sealing enclosure includes gas vents that are configured to release pressure from the hermetic sealing enclosure when pressure within the hermetic sealing enclosure is greater than a predetermined pressure. The hermetic sealing enclosure is made of a material selected from a group consisting of fabric, metal, composite material, rubber, polymer and/or combinations thereof.

In other features, the hermetic sealing enclosure includes a base portion and a cover configured to attach to the base portion. The hermetic sealing enclosure includes an opening and a drawstring configured to close the opening. The hermetic sealing enclosure includes an opening and a zipper configured to close the opening.

In other features, at least one of the side walls and the bottom surface include holes to reduce a weight of the structural housing component. The hermetic sealing enclosure is made of a flexible material that is rolled to close an opening of the hermetic sealing enclosure. The structural housing component includes a bottom surface, a frame and tubes extending between the bottom surface and the frame. A coating that is at least one of fire resistance and electrically insulating is arranged on at least one of an outer surface and an inner surface of the hermetic sealing enclosure.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an example of a hermetic sealing enclosure of a rechargeable energy storage system (RESS) enclosure according to the present disclosure;

FIG. 2 is a perspective view of an example of a structural housing component of a RESS enclosure according to the present disclosure;

FIG. 3 is a perspective view of an example of the hermetic sealing enclosure arranged in the structural housing component of the RESS enclosure according to the present disclosure;

FIG. 4 is a perspective view of an example of a base portion of the hermetic sealing enclosure including gas vents according to the present disclosure;

FIG. 5 is a perspective view of an example of a cover portion of the hermetic sealing enclosure including gas vents according to the present disclosure;

FIG. 6 is a perspective view of another example of a hermetic sealing enclosure that is made of flexible material according to the present disclosure;

FIG. 7 is a perspective view of an example of the hermetic sealing enclosure that is made of the flexible material installed in the structural housing component according to the present disclosure;

FIG. 8 is a perspective view of another example of a hermetic sealing enclosure including a zipper at an opening thereof according to the present disclosure;

FIG. 9 is a perspective view of another example of a hermetic sealing enclosure including a drawstring to close an opening thereof according to the present disclosure;

FIG. 10 is a perspective view of another example of a hermetic sealing enclosure including a zipper to close an opening thereof according to the present disclosure; and

FIG. 11 is a perspective view of another example of a structural housing component including tubes according to the present disclosure.

In the drawings, reference numbers may be reused to identify similar and/or identical elements.

### DETAILED DESCRIPTION

While the foregoing description relates to enclosures for rechargeable energy storage systems (RESS) for vehicles, the RESS enclosure can be used in other non-vehicle applications.

Rechargeable energy storage systems (RESS) are arranged in an enclosure. There are both load-bearing and hermetic sealing requirements for the enclosure of the RESS. Integration of both functions in the enclosure presents design and manufacturing challenges.

The enclosure for a RESS according to the present disclosure decouples the hermetic sealing function from the load-bearing function. The enclosure for a RESS according to the present disclosure includes a hermetic sealing enclosure that does not need to meet some or all of the structural functionality requirements. The RESS enclosure further includes a structural housing component that is designed to meet load requirements for non-structural implementations or to provide protection to the RESS during a crash event in structural implementations (without hermetic sealing requirements).

The decoupled design of the RESS enclosure relaxes design constraints and reduces manufacturing complexity for both the hermetic sealing enclosure and the structural housing component.

Referring now to FIG. 1, a hermetic sealing enclosure 10 of a RESS enclosure is shown. The hermetic sealing enclosure 10 includes a base portion 12 including side walls 14 and a bottom surface 16. While the hermetic sealing enclosure 10 has a generally rectangular shape, other regular or irregular shapes can be used. The hermetic sealing enclosure 10 further includes a cover portion 18 that is configured to close an opening of the base portion 12. In some examples, small venting holes are arranged in the cover 18 to release the gas generated by the batteries. In some examples, an inner surface and/or outer surface of the base portion 12 and/or the cover portion 18 include a fire-resistant and electrical insulating coating 24.

Referring now to FIG. 2, a structural housing component 50 of the RESS enclosure is shown. The structural housing component 50 includes a base portion 62 including side walls 64 and a bottom surface 66. The side walls 64 and/or bottom surface 66 of the structural housing component 50 may include holes 70 and 74. The holes 70 and 74 may correspond to locations of vent holes in the hermetic sealing enclosure 10, holes for lightening the structural housing component 50 (e.g., the holes are arranged in non-load bearing areas identified during structural optimization), access holes for passing electrical connections to the RESS, and/or for other uses.

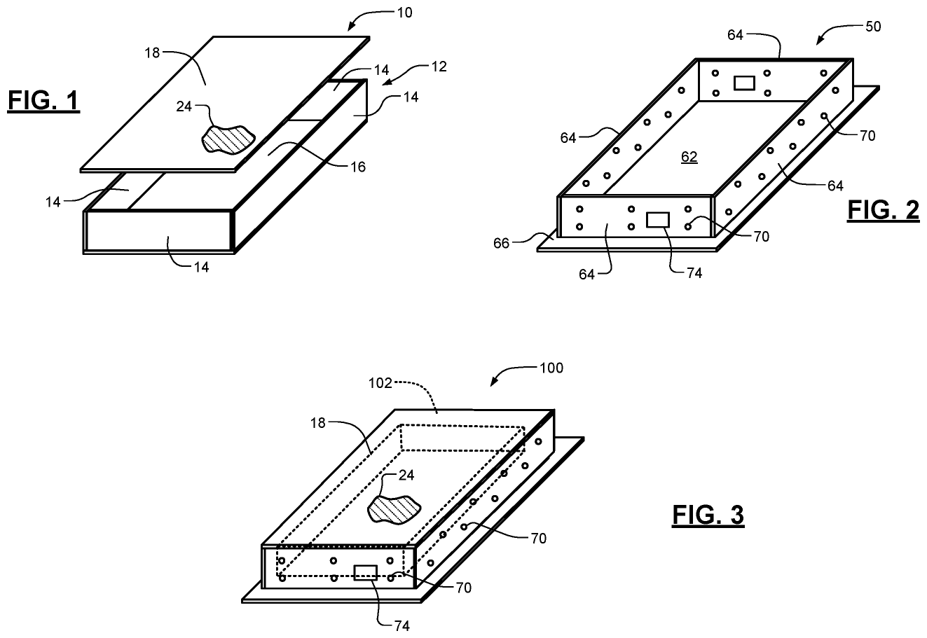

Referring now to FIG. 3, an enclosure 100 for a RESS 102 is shown. The hermetic sealing enclosure 10 is shown arranged on the structural housing component 50. The RESS 102 is arranged in the hermetic sealing enclosure 10.

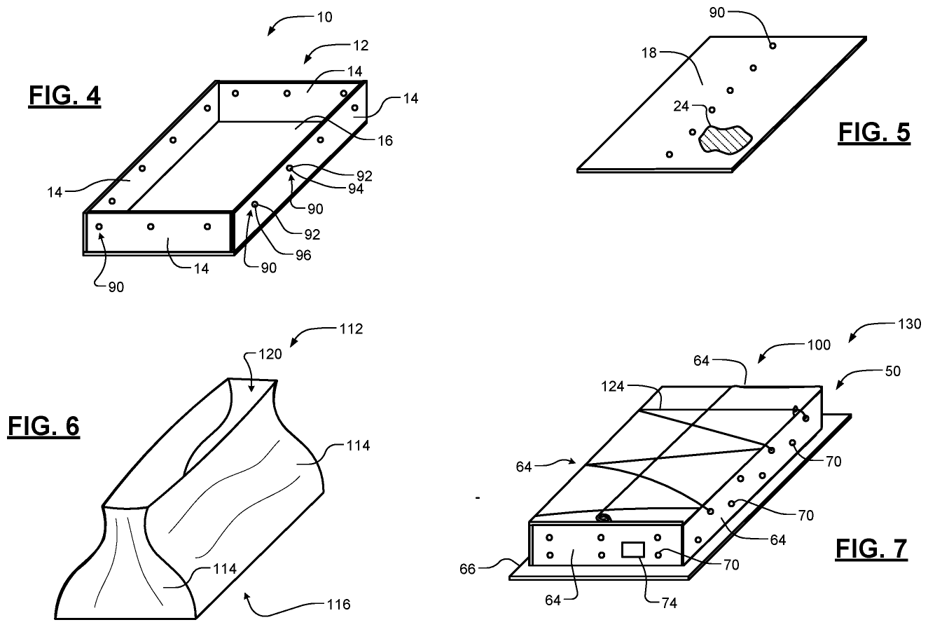

Referring now to FIGS. 4 and 5, the base portion 12 of the hermetic sealing enclosure 10 is shown to include one or more gas vents 90. In some examples, the gas vents 90 are aligned with one or more of the holes 70 and/or 74 in the structural housing component 50. In some examples, the gas vents 90 include pressure sensitive plugs 94 arranged in holes 92 in the hermetic sealing enclosure 10. The plugs 94 are configured to release pressure when pressure inside of the hermetic sealing enclosure 10 exceeds a predetermined pressure. Alternately, the holes 92 can be closed with a polymer layer 96 configured to release when pressure inside of the hermetic sealing enclosure 10 exceeds a predetermined pressure. In FIG. 5, the cover portion 18 of the hermetic sealing enclosure 10 is shown to including the gas vents 90.

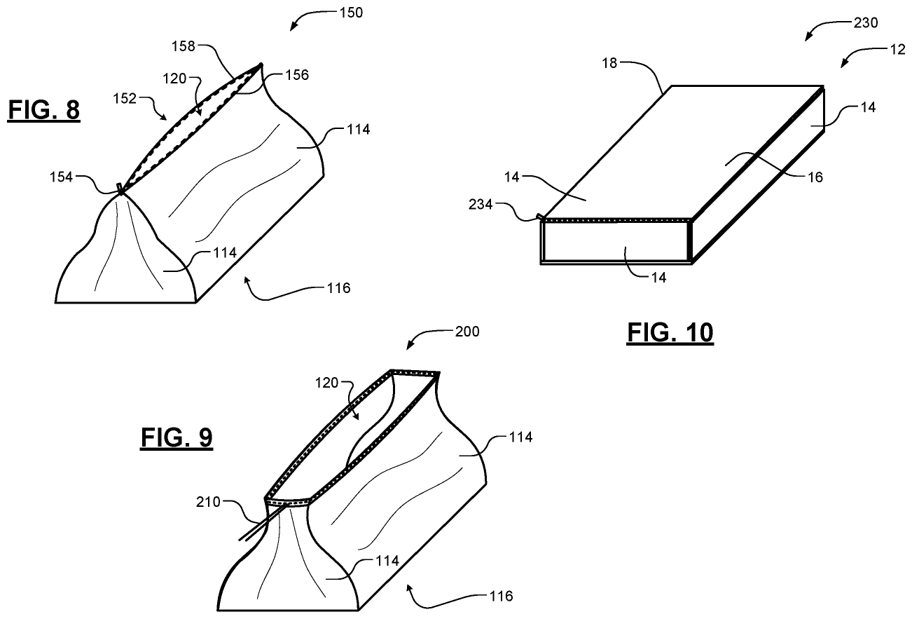

Referring now to FIGS. 6 and 7, a hermetic sealing enclosure 112 that is made of a flexible heat-resistant and electrical-insulating material such as rubber, polymer or fabric is shown separately (FIG. 6) and installed in the structural housing component 50 (FIG. 7). In some examples, an opening 120 of the hermetic sealing enclosure 112 is located on top portions of sides 114.

In some examples, the opening 120 is rolled to close the opening 120 and create a hermetic seal. In some examples, a drawstring 124 is used to secure the closed state of the rolled opening 120. The drawstring 124 may also secure the hermetic sealing enclosure 112 to the structural housing component 50 (e.g., using the holes 70 and/or 74). In other examples, a hook and loop fastener or other type of fastener is used to close the opening and/or to secure the hermetic sealing enclosure 112 to the structural housing component 50.

Referring now to FIG. 8, a hermetic sealing enclosure 150 includes a zipper 152 to close the opening 120. The zipper 152 includes a slider 154 that slides to engage or disengage teeth 156 and 158 arranged along opposite edges of the opening 120 of the hermetic sealing enclosure 150. Closing the zipper creates a hermetic seal. In this example, the hermetic sealing enclosure 150 is made of a flexible heat-resistant and electrical-insulating material such as fabric, rubber, polymer, or other flexible material.

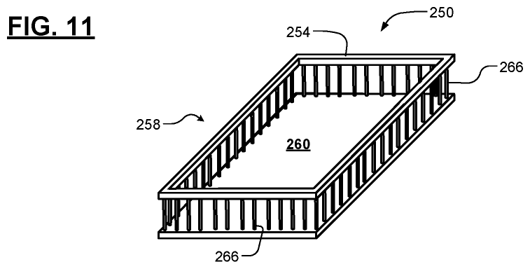

Referring now to FIG. 9, a hermetic sealing enclosure 200 is shown to include a drawstring 210 surrounding the opening 120 thereof. The drawstring 210 may be closed to create a hermetic seal. The RESS is inserted through the opening 120 and the drawstring 210 is tightened and tied to close the opening 120 and provide a hermetic seal.

Referring now to FIG. 10, a hermetic sealing enclosure 230 is shown to include a zipper 234 connecting one or more edges of the cover portion 18 to one or more corresponding edges of the base portion 12. The RESS is inserted through the opening and the zipper 234 is zipped to close the opening 120 and provide a hermetic seal.

Referring now to FIG. 11, a structural housing component 250 includes a bottom portion 260, a frame 254 and tubes 266 extending between the bottom portion 260 and the frame 254. The tubes 266 can be arranged at predetermined intervals around a periphery of the structural housing component 250. While the bottom portion 260 is shown as a plate, tubes can be used for the bottom portion by providing a lower frame (similar to the frame 264) to receive ends of the tubes.

As can be appreciated, the RESS enclosure according to the present disclosure decouples the hermetic sealing function from the structural and protection functions provided by the structural housing component. The decoupling of functions increases design freedom.

In some examples, the hermetic sealing enclosure is made of a flexible material with little or no structural integrity. In some examples, the hermetic sealing enclosure is made of a material selected from a group consisting of fabric, metal, composite material, rubber, polymer and/or combinations thereof. In some examples, the hermetic sealing enclosure is made using a thin, flexible, durable, and waterproof material selected from a group consisting of polymer, rubber, fabric, and combinations thereof.

In some examples, the hermetic sealing enclosure is made of stamped sheet metal forming the base portion and cover. In some examples, mating edges of the base portion are joined by welding or adhesive sealers as needed. The cover is arranged over the base portion to form the hermetic enclosure. In some examples, the base portion and/or the cover of the hermetic sealing enclosure are molded or 3D printed using polymer, composite materials and/or other materials that provide the hermetic sealing function.

In some examples, edges of the hermetic sealing enclosure are tied using rope or closed/opened using zippers to allow easy access during maintenance. In some examples, an outer surface of the hermetic sealing enclosure is coated with a fire-resistant coating for fire control. In some examples, the structural housing component that houses the hermetic enclosure and the RESS are manufactured with zero radius and right angles to optimize housing capacity.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. An enclosure for a rechargeable energy storage system (RESS), comprising:
a hermetic sealing enclosure; and
a structural housing component configured to support the hermetic sealing enclosure,
wherein the hermetic sealing enclosure is arranged on the structural housing component, and
wherein the hermetic sealing enclosure is configured to house the RESS and provide a hermetic seal.

2. The enclosure of claim 1, wherein the hermetic sealing enclosure includes:
a base portion; and
a cover configured to attach to the base portion.

3. The enclosure of claim 1, wherein the hermetic sealing enclosure includes an opening and a drawstring configured to close the opening.

4. The enclosure of claim 1, wherein the hermetic sealing enclosure includes an opening and a zipper configured to close the opening.

5. The enclosure of claim 1, wherein the structural housing component includes a bottom surface and side walls extending from the bottom surface and the hermetic sealing enclosure is arranged on the bottom surface between the side walls.

6. The enclosure of claim 5, wherein at least one of the side walls and the bottom surface include holes to reduce a weight of the structural housing component.

7. The enclosure of claim 1, wherein the hermetic sealing enclosure includes gas vents that are configured to release pressure from the hermetic sealing enclosure when pressure within the hermetic sealing enclosure is greater than a predetermined pressure.

8. The enclosure of claim 7, wherein the gas vents are selected form a group consisting of a pressure sensitive plug and a polymer layer arranged in a hole in the hermetic sealing enclosure.

9. The enclosure of claim 1, wherein the hermetic sealing enclosure is made of a material selected from a group consisting of fabric, metal, composite material, rubber, polymer and/or combinations thereof.

10. The enclosure of claim 1, wherein the hermetic sealing enclosure is made of a flexible material that is rolled to close an opening of the hermetic sealing enclosure.

11. The enclosure of claim 1, wherein the structural housing component includes a bottom surface, a frame and tubes extending between the bottom surface and the frame.

12. The enclosure of claim 1, further comprising a coating that is at least one of fire resistant and electrically insulating and that is arranged on at least one of an inner surface and an outer surface of the hermetic sealing enclosure.

13. An enclosure for a rechargeable energy storage system (RESS), comprising:
a hermetic sealing enclosure; and
a structural housing component including side walls extending from a bottom surface,
wherein the hermetic sealing enclosure is arranged on the bottom surface between the side walls,
wherein the hermetic sealing enclosure includes gas vents that are configured to release pressure from the hermetic sealing enclosure when pressure within the hermetic sealing enclosure is greater than a predetermined pressure, and
wherein the hermetic sealing enclosure is made of a material selected from a group consisting of fabric, metal, composite material, rubber, polymer and/or combinations thereof.

14. The enclosure of claim 13, wherein the hermetic sealing enclosure includes:
a base portion; and
a cover configured to attach to the base portion.

15. The enclosure of claim 13, wherein the hermetic sealing enclosure includes an opening and a drawstring configured to close the opening.

16. The enclosure of claim 13, wherein the hermetic sealing enclosure includes an opening and a zipper configured to close the opening.

17. The enclosure of claim 13, wherein at least one of the side walls and the bottom surface include holes to reduce a weight of the structural housing component.

18. The enclosure of claim 13, wherein the hermetic sealing enclosure is made of a flexible material that is rolled to close an opening of the hermetic sealing enclosure.

19. The enclosure of claim 13, wherein the structural housing component includes a bottom surface, a frame and tubes extending between the bottom surface and the frame.

20. The enclosure of claim 13, further comprising a coating that is at least one of fire resistance and electrically insulating and that is arranged on at least one of an outer surface and an inner surface of the hermetic sealing enclosure.
